(19) United States
(12) Patent Application Publication
(10) Pub. No.: US 2025/0313745 A1
(43) Pub. Date: Oct. 9, 2025

(54) METHODS TO SELECT BRINE RECIPES FOR WATERFLOODING OPERATIONS

(71) Applicant: Saudi Arabian Oil Company, Dhahran (SA)

(72) Inventors: Moataz Abu AlSaud, Khobar (SA); Salem Khaled Al-Shammari, Dhahran (SA); Hussain Habib Al Saleem, Al Rawdah (SA); Salah Hamad Al-Saleh, Dhahran (SA); Subhash Ayirala, Dhahran (SA)

(21) Appl. No.: 18/625,698

(22) Filed: Apr. 3, 2024

(51) Int. Cl. C09K 8/58

(52) U.S. Cl. CPC C09K 8/58

(57) ABSTRACT

The disclosure relates to methods to study and select a brine recipe for waterflooding by preparing brine recipes with different ions, measuring the zeta-potentials of the prepared brine recipes, measuring contact angles of the prepared brine recipes with the lowest zeta-potentials, and developing and using a model to rationalize the results.

### TECHNICAL FIELD

The disclosure relates to methods to study and select a brine recipe for waterflooding by preparing brine recipes with different ions, measuring the zeta-potentials of the prepared brine recipes, measuring contact angles of the prepared brine recipes with the lowest zeta-potentials, and developing and using a model to rationalize the results.

### BACKGROUND

A detailed understanding of the physicochemical processes relevant to hydrocarbon production from a subterranean formation can improve efficiency and effectiveness of the hydrocarbon production. Water injection is one method to improve hydrocarbon recovery. Depending on the water source location, the water or brine injected can include underground aquifer water, surface water, and/or seawater.

### SUMMARY

In a first aspect, the disclosure provides a method for selecting a brine recipe for a waterflooding process in a target formation, the method including: measuring zeta-potentials for a first set of brine recipes; forming a second set of brine recipes including a subset of the first set of brine recipes based on the measured zeta-potentials; measuring contact angles of the second set of brine recipes; using a model to rationalize results of at least one experimental result selected from the measured zeta-potentials and the measured contact angles; and based on the measured zeta-potentials, the measured contact angles, and the model, selecting a brine recipe for the target formation.

In some embodiments, the method further includes, prior to measuring the zeta-potentials, preparing a first set of brine recipes. In some embodiments, the first set of brine recipes includes two or more brine recipes and each brine recipe includes a distinct formulation. In some embodiments, each brine recipe in the first set of brine recipes includes one or more baseline solutions and one or more experimental formulations including a baseline solution and one or more salt additives. In some embodiments, the one or more salt additives include at least one member selected from the group consisting of an iodide salt, a phosphate salt, a sulfate salt, and a borate salt. In some embodiments, the one or more salt additives include at least one member selected from the group consisting of sodium dihydrogen phosphate, potassium dihydrogen phosphate sodium iodide, potassium iodide, sodium sulfate, potassium sulfate, magnesium sulfate, and borax. In some embodiments, a pH of each experimental formulation is from about 5 to about 10.

In some embodiments, forming the second set of brine recipes includes selecting two or more brine recipes with the lowest measured zeta-potentials.

In some embodiments, measuring the zeta-potentials for the first set of brine recipes includes measuring the zeta-potential of each brine recipe in the first set of brine recipes with a ground mineral representative of the target formation.

In some embodiments, measuring the zeta-potentials for the first set of brine recipes includes measuring the zeta-potential of each brine recipe in the first set of brine recipes with crude oil.

In some embodiments, selecting a brine recipe for the target formation includes selecting a brine recipe with the lowest measured contact angle.

In some embodiments, the contact angle measurement includes measuring the contact angles of crude oil on a rock sample from the target formation with each of the second set of brine recipes.

In some embodiments, using the model to rationalize the results includes determining surface complexation reactions for the target formation with divalent cations and the one or more salt additives to form a surface complexation model including the surface complexation reactions; and varying intrinsic equilibrium constants of the surface complexation reactions to match the measured zeta-potentials. In some embodiments, the target formation includes a carbonate formation. In some embodiments, the one or more salt additives includes a phosphate salt and the surface complexation reactions include:

| | Equilibrium |
|---|---|
| | Constant |
| Calcite Surface Reaction | (log₁₀ Kᵢₙₜ) |
| >CaOH + Mg²⁺ + H₂PO₄⁻ ↔ >CaOMgHPO₄⁻ + 2H⁺ | −7.35 |
| >CaOH + Ca²⁺ + H₂PO₄⁻ ↔ >CaOCHPO₄⁻ + 2H⁺ | −6.65 |
| >CaOH + Mg²⁺ + H₂PO₄⁻ ↔ >CaOMgH₂PO₄ + H⁺ | −2.65 |
| >CaOH + Ca²⁺ + H₂PO₄⁻ ↔ >CaOCaH₂PO₄ + H⁺ | −4.35 |

### DESCRIPTION OF DRAWINGS

FIG. 1 shows various ions inside a thin-film water layer squeezed between a calcite surface and crude oil.

FIG. 2 shows a flowchart for an exemplary method of selecting a brine recipe for a target formation.

FIG. 3 shows a schematic for a contact angle measurement.

FIG. 4 shows zeta potential values at a calcite/brine interface for SmartWater with different salt additives.

FIG. 5 shows zeta potential values at a calcite/brine interface for seawater with different salt additives.

FIG. 6 shows zeta potential values at a calcite/brine interface for sulfate-based recipe with different salt additives.

FIG. 7 shows zeta potential values at an oil/brine interface for SmartWater with different salt additives.

FIG. 8 shows zeta potential values at an oil/brine interface for seawater with different salt additives.

FIG. 9 shows zeta potential values at an oil/brine interface for sulfate-based recipe with different salt additives.

FIG. 10A shows a contact angle measurement for seawater without any salt additives.

FIG. 10B show a contact angle measurement for seawater with 1000 ppm sodium dihydrogen phosphate.

FIG. 11 shows experimental and modeled zeta potential values for different brine solutions at a calcite/brine interface.

### DETAILED DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Provided in the present disclosure are methods to study and select a brine recipe for waterflooding. In some embodiments, the method includes preparing brine recipes with different ions, measuring the zeta-potentials of the prepared brine recipes, measuring contact angles of the prepared brine recipes with the lowest zeta-potentials, and developing and using a model to rationalize the results.

The methods can improve and optimize waterflooding operations based on the concentration of specific anions that affect the wettability parameter. The methods can improve injection flooding operations to increase hydrocarbon recovery and reduce the carbon footprint of the flooding operation by reducing the volume of injection water used and/or reducing the amount of water produced.

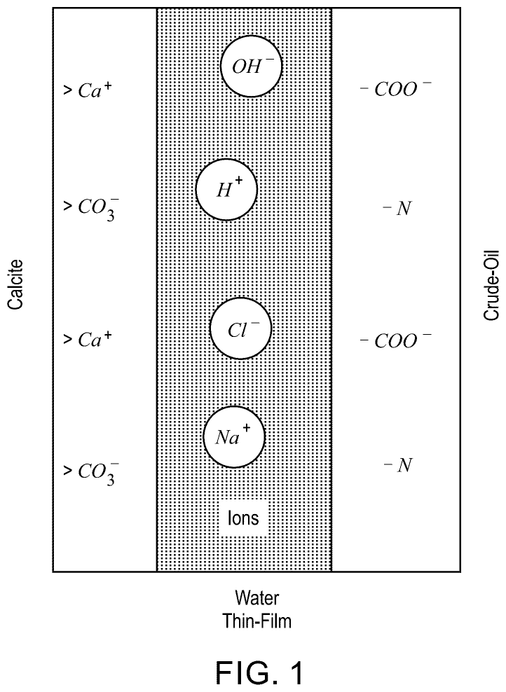

FIG. 1 depicts different ions in a water thin-film between calcite and crude oil surfaces from a brine. Without wishing to be bound theory, it is believed that dissolved ions can be adsorbed on the crude oil, calcite and brine surfaces, thereby creating an overall surface charge on each interface. The surface charge has a corresponding zeta-potential electrokinetic parameter that can be experimentally measured.

Without wishing to be bound by theory, it is believed that for a pH range between about 5 and about 8, the brine/crude oil zeta-potential is negatively charged due to the carboxylate groups in the crude oil surface, while the brine/carbonate zeta-potential is positive due to dissolved magnesium and calcium ions in brine solutions that interact and adsorb on the calcite surface. It is further believed that adding certain anions (such as iodide, sulfate, and/or borate) into the brine solution can alter the brine/carbonate zeta-potential to become negative, thereby creating a repulsion between the brine/carbonate and brine/crude oil interfaces. This electrostatic repulsion alters the wettability towards more water-wet, and thereby leads to additional oil recovery.

Without wishing to be bound by theory, it is believed that injection water salinity influences hydrocarbon recovery from formations (e.g., carbonate formations) due to its strong effect on wettability. Specifically, certain ions are believed to have a favorable effect on wettability, while certain other ions are believed to have minimal or no effect on wettability. The surface charges and zeta-potential can be altered by the ionic composition of the brine.

### Definitions

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting. All publications, patent applications, patents, sequences, database entries, and other references mentioned in this document are incorporated by reference in their entirety. In case of conflict, the present specification, including definitions, will control.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used in this disclosure, the term “subterranean formation” can refer to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region that is in fluid contact with the wellbore. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground that is in fluid contact with liquid or gaseous petroleum materials or water. In some embodiments, a subterranean formation is an oil well.

As used in this disclosure, the term “waterflooding” refers to a method of secondary recovery in which water is injected into the subterranean formation to displace residual hydrocarbons, such as oil, and increase the production of the hydrocarbon from the subterranean formation. The water from injection wells physically sweeps the displaced hydrocarbon, such as oil, to adjacent production wells.

### Methods of Selecting a Brine Recipe for a Target Formation

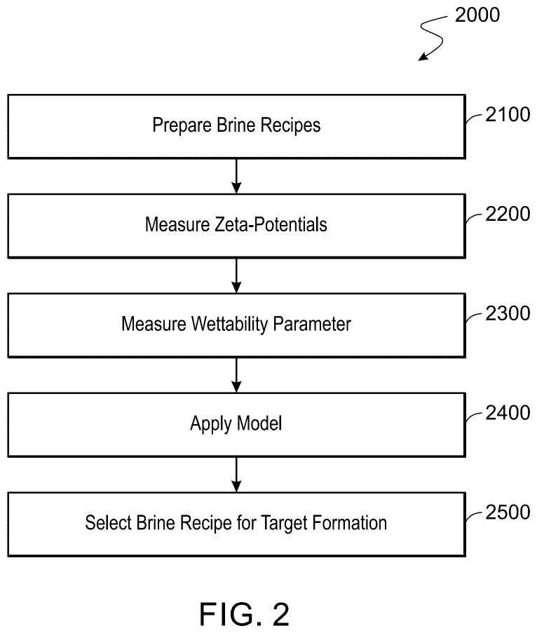

Provided in the present disclosure are methods of selecting a brine recipe for a target formation. FIG. 2 shows a flowchart for a method of selecting a brine recipe for a target formation (e.g., a subterranean formation) such as provided in the present disclosure. In general, the target formation includes a carbonate formation.

In step 2100, a set of brine recipes is prepared. The brine recipes include a baseline solution such as underground aquifer water, surface water, and/or seawater, and one or more salt additives, such as a phosphate salt (e.g., sodium dihydrogen phosphate (NaH₂PO₄), potassium dihydrogen phosphate (KH₂PO₄)), an iodide salt (e.g., sodium iodide (NaI), potassium iodide (KaI)), a sulfate salt (e.g., sodium sulfate (Na₂SO₄), potassium sulfate (K₂SO₄), magnesium sulfate (MgSO₄)), and/or a borate salt (e.g., borax (Na₂B₄O₇·10H₂O)). In general, the number of brine recipes prepared will depend on the scope of the study. Without wishing to be bound by theory, it is believed that the salt additives can alter the zeta-potentials, wettability, and/or pH of the brine recipe. It is also believed that the effect of the cations (e.g., sodium ions, potassium ions) have an almost negligible effect on the wettability and the anions predominantly impact the wettability.

In some embodiments, the pH of the brine recipes is at least about 5 (e.g., at least about 5.5, at least about 6, at least about 6.5, at least about 7, at least about 7.5, at least about 8, at least about 8.5, at least about 9, at least about 9.5 and/or at most about 10 (e.g., at most about 9.5, at most about 9, at most about 8.5, at most about 8, at most about 7.5, at most about 7, at most about 6.5, at most about 6, at most about 5.5). Without wishing to be bound by theory, it is believed that such a pH may be desirable in carbonate formations as the pH is sufficiently low to cause dissolution of carbonate thereby increasing permeability without being sufficiency low to cause corrosion of a component used for water injection and/or hydrocarbon production. Additionally, it is believed that a pH below 5 may cause corrosion and a pH above 10 may cause precipitation.

Without wishing to be bound by theory, it is believed that relatively high concentrations of sulfates can cause scaling, though this is influenced by the pH and concentrations of calcium, magnesium, and strontium ions. It is further believed that generally, a sulfates concentration over about 5000 ppm may cause scaling.

In step 2200, the zeta-potentials are measured for the set of brine recipes as well as the baseline solution(s) used. The zeta-potentials can be measured by any appropriate method, such as by phase-analysis light scattering. The zeta-potentials at the brine/target formation interface can be measured by combining a ground mineral representative of the target formation (e.g., ground calcite for a carbonate formation) to each brine sample. Additionally, the zeta-potentials at the crude oil/brine interface can be measured by adding crude oil to each brine sample. A subset of the brine recipes is defined as the brine recipes with the lowest zeta-potentials. Without wishing to be bound by theory, it is believed that typically, the crude oil/brine interface is negatively charged. Thus, measurements of the crude oil/brine interface may be less critical than measurement of the brine/calcite interface. However, measurements of both interfaces will provide more insights and better confirm wettability alterations.

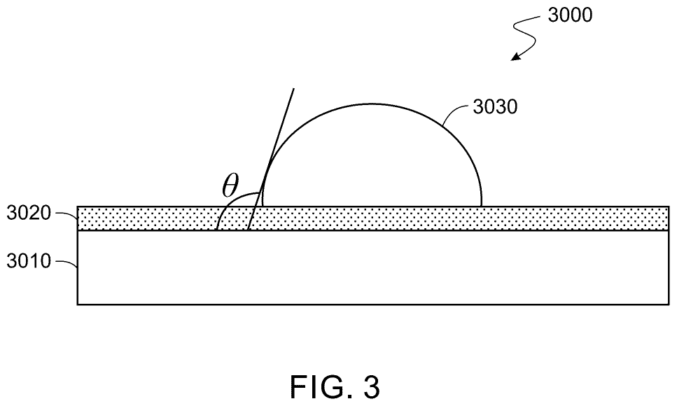

In step 2300, the wettability parameter of each brine recipe in the subset of brine recipes is measured. The wettability parameter can be measured by measuring the observed contact angle for a flat sample from the target formation with the brine recipe and a crude oil sample from the target formation, as shown in FIG. 3. FIG. 3 shows a schematic for a contact angle measurement 3000. A sample from the target formation 3010 is provided. For a carbonate formation, the flat sample from the target formation 3010 is a flat carbonate chip. The brine recipe is disposed atop the sample from the target formation 3010 and forms a film 3020. A crude oil sample from the target formation is placed atop the film 3020 and forms a crude oil droplet 3030. The angle θ corresponds to the contact angle. A brine recipe is selected with the smallest contact angle. Without wishing to be bound by theory, it is believed that a decrease in the contact angle due to the addition of a salt additive indicates a shift to more water-wet conditions, which can increase hydrocarbon production from the target formation.

In step 2400, a surface complexation model (SCM) is developed to understand and rationalize the results from the measurements by describing the ions' adsorption on the target formation. The SCM can be used to describe the equilibrium state of ion adsorption based on specified surface reactions. Additionally, the SCM can be used to predict ion adsorption to surfaces of the target formation and/or the crude oil. The affinity of different ion types is determined through surface chemistry reactions describing the formation (e.g., calcite) and crude oil surfaces. For example, Table 1 provides the surface complexation reactions for calcite with divalent cations and dihydrogen phosphate. Without wishing to be bound by theory, it is believed that there is a specific surface reaction for each ion and particular rock formation.

TABLE 1
surface complexation reactions for calcite with
divalent cations and dihydrogen phosphate.

| | Equilibrium |
|---|---|
| | Constant |
| Calcite Surface Reaction | (log₁₀ Kᵢₙₜ) |
| >CaOH + Mg²⁺ + H₂PO₄⁻ ↔ >CaOMgHPO₄⁻ + 2H⁺ | −7.35 |
| >CaOH + Ca²⁺ H₂PO₄⁻ ↔ >CaOCHPO₄⁻ + 2H⁺ | −6.65 |
| >CaOH + Mg²⁺ H₂PO₄⁻ ↔ >CaOMgH₂PO₄ + H⁺ | −2.65 |
| >CaOH + Ca²⁺ H₂PO₄⁻ ↔ >CaOCH₂PO₄ + H⁺ | −4.35 |

The intrinsic equilibrium constants are varied in the surface complexation model to match the measured zeta-potentials for the different brine recipes. The number of fitting parameters is equal to the number of surface reaction equations.

In the model, the concentration of adsorbed surfaces complexes (adsorbed ions) determines the total surface charge according to the equation:

$$σ = \frac{F}{SA} \sum {z}_{i} {c}_{i}$$

where σ is the surface charge density (C/m²), F is the Faraday constant (96493.5 C/mol), S is the surface material mass (g), A is the specific surface area (m²/g), zᵢ is the ionic electric charge, and cᵢ is the adsorbed ion concentration (mol). The surface charge and surface-potential are related through the Gouy-Chapman model:

$$σ = \sqrt{8000 {ϵ}_{o} {ϵ}_{w} RTI} sinh ( \frac{vF Ψ}{2 RT} )$$

where ϵₒ is the vacuum permittivity C²/mJ, ϵ_{w} is the water relative permittivity, Ψ is the surface-potential (V), R is the gas constant (J/mol K), T is the temperature (K), I is the brine ionic strength (mol/l), and v is the electrolyte ionic charge which is assumed to be unity. The site density for calcite surface is 4.95 sites/nm², while the crude oil surface has a site density of 0.47 sites/nm². The calcite specific surface area is 1 m²/g, while the crude oil specific area is 0.5 m²/g.

The modeling framework can be used to rationalize why a given brine recipe exhibits good results for a specific formation. Additionally, once the model is validated by determining the values of the modified equilibrium constants, additional brine recipes can be analyzed using the model without having to conduct additional experiments. Without wishing to be bound by theory, it is believed that the model is applicable for anions included in the model's reaction at any concentration.

In the step 2500, based on the measured zeta-potentials from the step 2200, the measured contact angles from the step 2300, and the model from the step 2400, a brine recipe for the target formation is selected. In some embodiments, the selected brine recipe is the brine recipe with the largest wettability, corresponding to the lowest measured contact angle.

In addition to or in alternative to measuring zeta-potentials by phase-analysis light scattering, any suitable method can be used to measure the electrokinetics of the brine recipes in the step 2200, such as electro-osmosis and streaming potential. In addition to or in alternative to measuring contact angles, atomic force microscopy can be used to provide fundamental details about the molecular forces involved in the wettability parameter in the step 2300.

### EXAMPLE

Brine recipes were prepared by adding 500 ppm or 1000 ppm of sodium dihydrogen phosphate (NaH₂PO₄), sodium iodide (NaI), sodium sulfate (Na₂SO₄), or borax (Na₂B₄O₇·10H₂O) into SmartWater, seawater, and a sulfate-based brine. Table 2 provides the ionic compositions of the baseline solutions.

TABLE 2
composition of different brines
Brine samples (concentration mg/L)

| | Seawater | SmartWater | Sulfate−based brine |
|---|---|---|---|
| Na⁺ | 18,300 | 1824 | 1865 |
| Cl⁻ | 32,200 | 3220 | — |
| Ca²⁺ | 650 | 65 | — |
| Mg²⁺ | 2,110 | 211 | — |
| SO₄⁻² | 4,290 | 429 | 3896 |
| HCO₃⁻ | 120 | — | — |
| Total dissolved | 57,670 | 5,761 | 5,761 |
| Solids, ppm | | | |
| Initial pH | 7.66 | 7.29 | 6.58 |

Oil/brine emulsions were prepared by adding a single drop of oil to 5 mL of each brine sample. For the calcite/brine suspensions, 20 mL of each brine sample was mixed with 0.1 g of fine powder of ground calcite. Sonification was done after each step involving a suspension to prevent the agglomeration of particles. Then, the samples were placed inside phase-analysis light scattering instrument (ZetaPals).

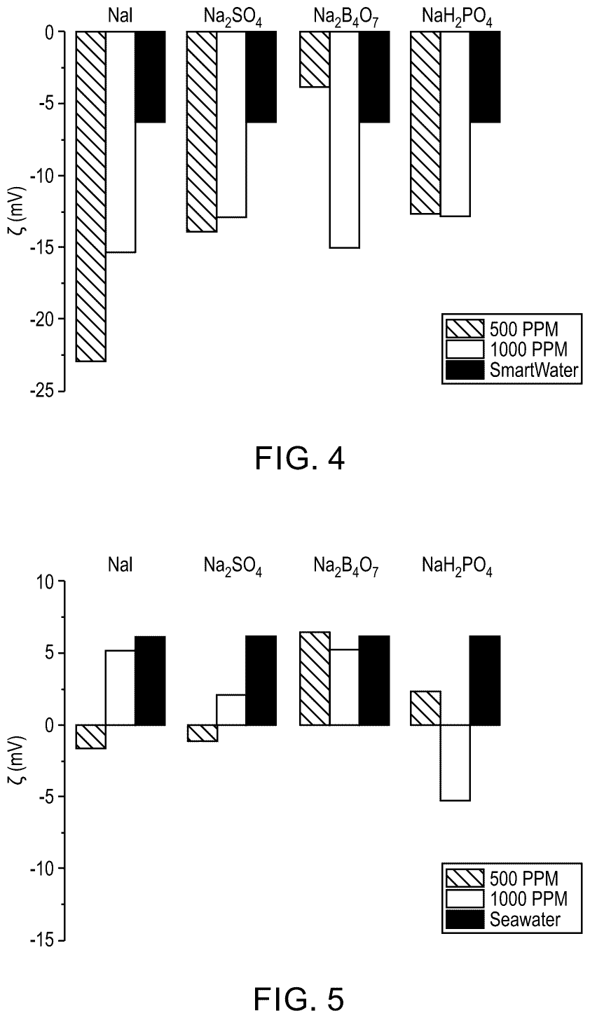

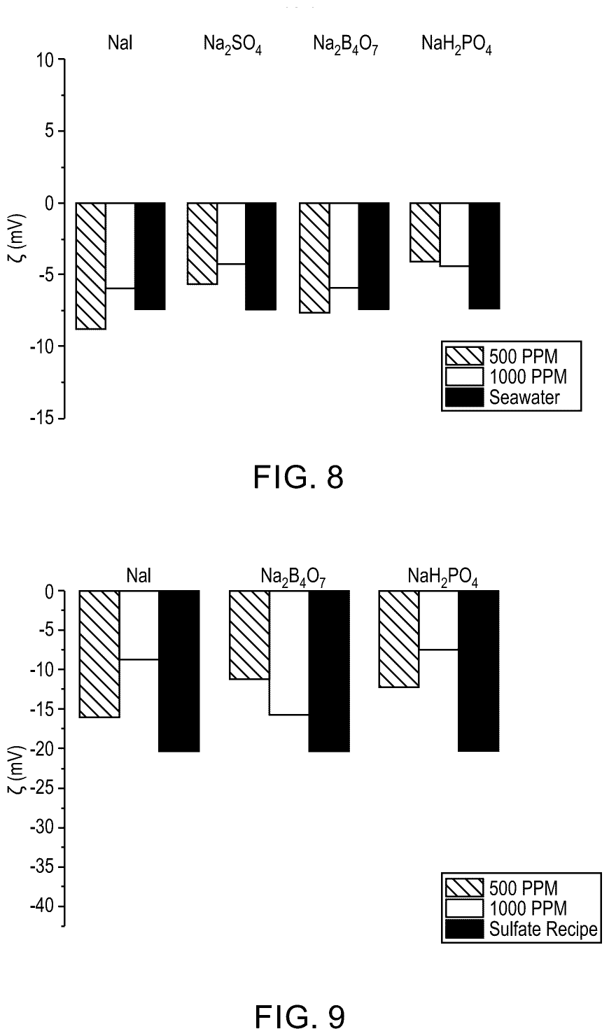

FIGS. 4-6 and FIGS. 7-9 show the zeta-potential measurements for brine/calcite and crude oil/brine interfaces, respectively, under atmospheric conditions.

The results indicate that the different salt additives synergize with SmartWater recipe, which push the zeta-potential values towards negative values as shown in FIG. 4. The most effective salt additive in decreasing the zeta-potentials for SmartWater was 500 ppm of NaI.

FIG. 5 shows the zeta-potentials for seawater recipes as a baseline as well as with the four considered salt additives. The seawater recipe with 1000 ppm of NaH₂PO₄ resulted in a significant decrease in the zeta-potential. The surface-charge polarity switched from positive to negative, where the zeta-potential had dropped from 7 mV for the seawater baseline recipe to about −6 mV with 1000 ppm of NaH₂PO₄. Typically, seawater includes relatively high concentrations of divalent cations (Mg⁺² and Ca⁺² as shown in Table 1), resulting in a positive surface charge. Without wishing to be bound by theory, it is believed that adding dihydrogen phosphate ions created surface complexes adsorbed on the calcite which caused the surface charge to switch to a negative value. The addition of NaH₂PO₄ also decreased the pH from about 7.5 to 5.5. Without wishing to be bound by theory, it is believed that this decrease in pH provides a favorable effect, where precipitation is mitigated while slight dissolution can take place to improve potential formation damage in the reservoir. Although a pH of 5.5 is acidic, it can be considered non-corrosive, making it suitable for water injection in the field.

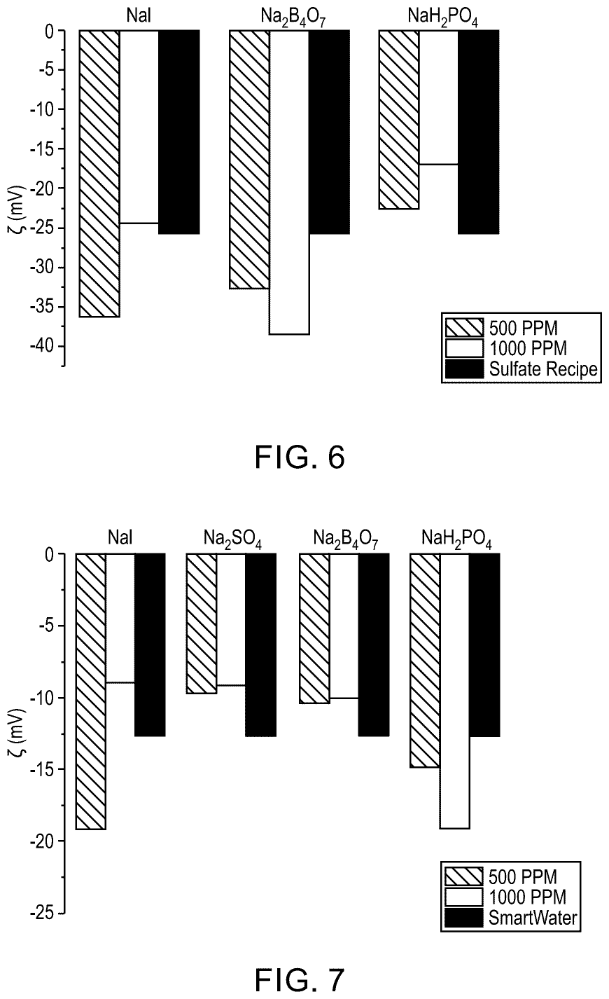

FIG. 6 illustrates the sulfate-based recipe with three different salts. As expected, the zeta-potentials are negative due to sulfate ions, while there are no divalent cations to alter the electrokinetics of the calcite surface to positive charge. Although the negative surface charge is favorable, the relatively high content of sulfates can cause scaling issues in the field, especially near the well-bore region and deep in the reservoir, which can adversely impact oil productivity.

Without wishing to be bound by theory, it is believed that at an oil/brine interface, the surface charges are mainly negative due to carboxylate groups in the crude oil. This can be observed in all measured zeta-potentials shown in FIGS. 7-9. Adding different salts to the baseline solutions slightly altered the magnitude of zeta-potentials. The major impact of adding the salt additives can be observed on the calcite/brine interface, particularly for sodium iodide and sodium dihydrogen phosphate, which caused the wettability alteration and contact angle change, as discussed above. The added salts did not change the magnitude or surface charge of the crude-oil/brine interface.

Based on the zeta-potential measurements, SmartWater with 500 ppm of NaI, and seawater with 1000 ppm of NaH₂PO₄ were determined as the most promising recipes for the target reservoir and selected for subsequent analysis by contact angle measurements.

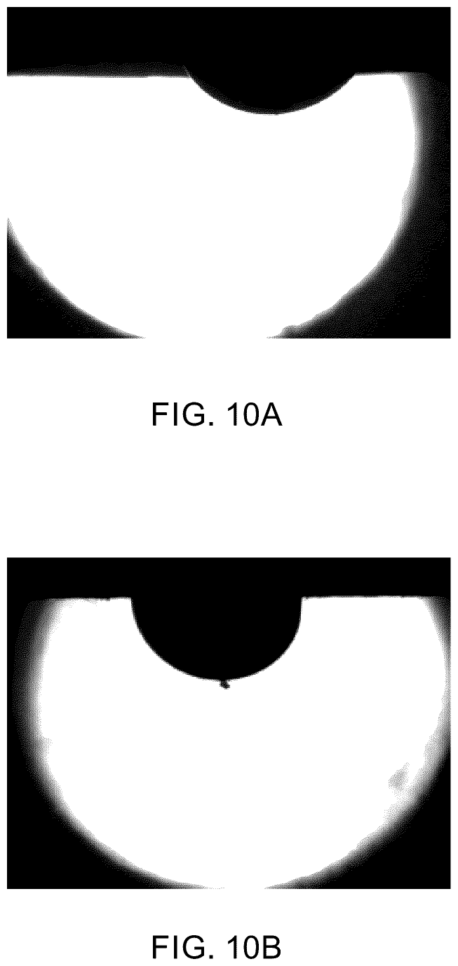

For contact angle measurements, the carbonate sample was mounted inside the contact angle chamber, and the brine recipe was injected on top of the carbonate sample. Once the chamber was filled and no leakage was observed, an oil needle was used to place a droplet at the surface of the chip as shown in FIGS. 10A-10B. A video camera filmed the surface with the drop, and an image-based analysis software was used to calculate the contact angle based on the images.

FIGS. 10A and 10B show contact angle measurement for seawater without any salt additives and with 1000 ppm sodium dihydrogen phosphate, respectively. The seawater without any salt additives shown in FIG. 10A had a contact angle of 135 degrees and the seawater with 1000 ppm sodium dihydrogen phosphate shown in FIG. 10B had a contact angle of 90 degrees.

The contact angles for the SmartWater without and with NaI were both measured as 118 degrees. Surprisingly, adding 500 ppm of NaI did not alter the contact angle value, which was nearly identical to the measured contact angle of the SmartWater baseline recipe. In contrast, seawater with 1000 ppm NaH₂PO₄ had a positive impact on the wettability where the contact angle decreased by 45 degrees pushing the system towards more water-wet conditions, as shown in FIGS. 10A-10B. Therefore, for this target formation seawater with 1000 ppm of NaH₂PO₄ was identified as the most promising brine recipe.

A surface complexation model was developed to rationalize the observed behavior in the dihydrogen phosphate-based seawater recipe. To validate the developed surface complexation model, the experimental zeta-potential values were history-matched with predicted model values by manipulating the surface-reaction equilibrium constants.

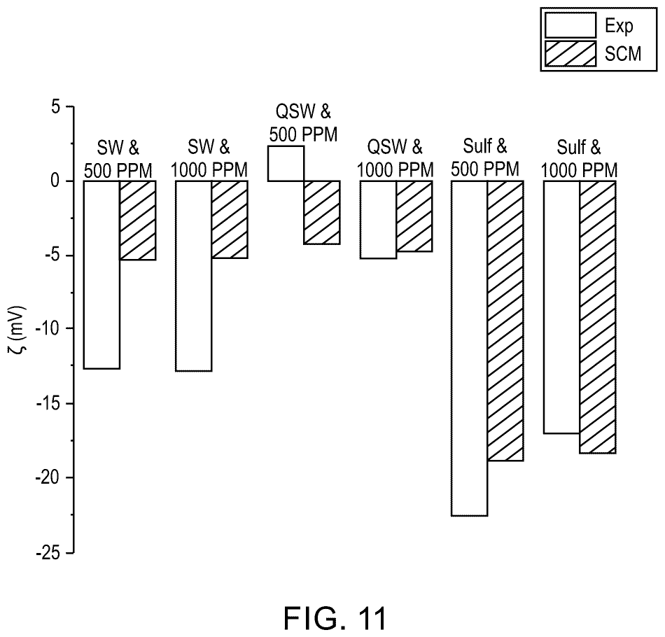

FIG. 11 illustrates the comparison between the experimental and modeling results for a calcite/brine interface, showing that the trend was qualitatively captured. The history-matching was achieved by including surface reactions that capture the formation of dihydrogen phosphate ions on top of divalent cations as shown in Table 1. Without wishing to be bound by theory, it is believed that the dihydrogen phosphate ions bind as a ternary component that mitigate the effect of positive divalent cations (magnesium and calcium), resulting in an overall negative surface-charge with a corresponding negative zeta-potential. Additional evidence that supports the dihydrogen phosphate adsorption mechanism on divalent cations (described by Table 1 reactions) is the zeta-potential measurements for the sulfate-based brine (shown in FIG. 6). It was observed that the addition of dihydrogen phosphate ions reduced the magnitude of the negative zeta-potential. This is due to decrease in the pH, where the increase in hydrogen protons (H⁺) slightly pushed the surface charge towards positive direction. Also, the dihydrogen phosphate ions were ineffective in sulfate-based brines due to lack of divalent cations.

The results indicated that adding sodium dihydrogen phosphate to the injection seawater showed favorable results in experiments and modeling by altering the crude oil/brine/carbonate system wettability to become more water-wet in the target formation. In addition, it also lowered the pH from about 7.5 to 5.5, which can reduce potential formation damage from scale formation and increase the permeability (due to rock dissolution) in subterranean carbonate formations.

### Embodiments 1. A method for selecting a brine recipe for a waterflooding process in a target formation, the method including:

measuring zeta-potentials for a first set of brine recipes;

forming a second set of brine recipes including a subset of the first set of brine recipes based on the measured zeta-potentials;

measuring contact angles of the second set of brine recipes;

using a model to rationalize results of at least one experimental result selected from the measured zeta-potentials and the measured contact angles; and

based on the measured zeta-potentials, the measured contact angles, and the model, selecting a brine recipe for the target formation.

2. The method of embodiment 1, further including, prior to measuring the zeta-potentials, preparing a first set of brine recipes.

3. The method of embodiment 1 or 2, wherein the first set of brine recipes includes two or more brine recipes and each brine recipe includes a distinct formulation.

4. The method of embodiment 3, wherein each brine recipe in the first set of brine recipes includes one or more baseline solutions and one or more experimental formulations including a baseline solution and one or more salt additives.

5. The method of embodiment 4, wherein the one or more salt additives include at least one member selected from the group consisting of an iodide salt, a phosphate salt, a sulfate salt, and a borate salt.

6. The method of embodiment 5, wherein the one or more salt additives include at least one member selected from the group consisting of sodium dihydrogen phosphate, potassium dihydrogen phosphate sodium iodide, potassium iodide, sodium sulfate, potassium sulfate, magnesium sulfate, and borax.

7. The method of any one of embodiments 4-7, wherein a pH of each experimental formulation is from about 5 to about 10.

8. The method of any one of embodiments 1-7, wherein forming the second set of brine recipes includes selecting two or more brine recipes with the lowest measured zeta-potentials.

9. The method of any one of embodiments 1-8, wherein measuring the zeta-potentials for the first set of brine recipes includes measuring the zeta-potential of each brine recipe in the first set of brine recipes with a ground mineral representative of the target formation.

10. The method of any one of embodiments 1-9, wherein measuring the zeta-potentials for the first set of brine recipes includes measuring the zeta-potential of each brine recipe in the first set of brine recipes with crude oil.

11. The method of any one of embodiments 1-10, wherein selecting a brine recipe for the target formation includes selecting a brine recipe with the lowest measured contact angle.

12. The method of any one of embodiments 1-11, wherein the contact angle measurement includes measuring the contact angles of crude oil on a rock sample from the target formation with each of the second set of brine recipes.

13. The method of any one of embodiments 4-12, wherein using the model to rationalize the results includes:

determining surface complexation reactions for the target formation with divalent cations and the one or more salt additives to form a surface complexation model including the surface complexation reactions; and

varying intrinsic equilibrium constants of the surface complexation reactions to match the measured zeta-potentials.

14. The method of embodiment 13, wherein the target formation includes a carbonate formation.

15. The method of embodiment 14, wherein the one or more salt additives includes a phosphate salt and the surface complexation reactions include:

| | Equilibrium |
|---|---|
| | Constant |
| Calcite Surface Reaction | (log₁₀ Kᵢₙₜ) |
| >CaOH + Mg²⁺ + H₂PO₄⁻ ↔ >CaOMgHPO₄⁻ + 2H⁺ | −7.35 |
| >CaOH + Ca²⁺ + H₂PO₄⁻ ↔ >CaOCHPO₄⁻ + 2H⁺ | −6.65 |
| >CaOH + Mg²⁺ + H₂PO₄⁻ ↔ >CaOMgH₂PO₄ + H⁺ | −2.65 |
| >CaOH + Ca²⁺ + H₂PO₄⁻ ↔ >CaOCH₂PO₄ + H⁺ | −4.35 |

What is claimed is:

1. A method for selecting a brine recipe for a waterflooding process in a target formation, the method comprising:
measuring zeta-potentials for a first set of brine recipes;
forming a second set of brine recipes comprising a subset of the first set of brine recipes based on the measured zeta-potentials;
measuring contact angles of the second set of brine recipes;
using a model to rationalize results of at least one experimental result selected from the measured zeta-potentials and the measured contact angles; and
based on the measured zeta-potentials, the measured contact angles, and the model, selecting a brine recipe for the target formation.

2. The method of claim 1, further comprising, prior to measuring the zeta-potentials, preparing a first set of brine recipes.

3. The method of claim 1, wherein the first set of brine recipes comprises two or more brine recipes and each brine recipe comprises a distinct formulation.

4. The method of claim 3, wherein each brine recipe in the first set of brine recipes comprises one or more baseline solutions and one or more experimental formulations comprising a baseline solution and one or more salt additives.

5. The method of claim 4, wherein the one or more salt additives comprise at least one member selected from the group consisting of an iodide salt, a phosphate salt, a sulfate salt, and a borate salt.

6. The method of claim 5, wherein the one or more salt additives comprise at least one member selected from the group consisting of sodium dihydrogen phosphate, potassium dihydrogen phosphate sodium iodide, potassium iodide, sodium sulfate, potassium sulfate, magnesium sulfate, and borax.

7. The method of claim 4, wherein a pH of each experimental formulation is from about 5 to about 10.

8. The method of claim 1, wherein forming the second set of brine recipes comprises selecting two or more brine recipes with the lowest measured zeta-potentials.

9. The method of claim 1, wherein measuring the zeta-potentials for the first set of brine recipes comprises measuring the zeta-potential of each brine recipe in the first set of brine recipes with a ground mineral representative of the target formation.

10. The method of claim 1, wherein measuring the zeta-potentials for the first set of brine recipes comprises measuring the zeta-potential of each brine recipe in the first set of brine recipes with crude oil.

11. The method of claim 1, wherein selecting a brine recipe for the target formation comprises selecting a brine recipe with the lowest measured contact angle.

12. The method of claim 1, wherein the contact angle measurement comprises measuring the contact angles of crude oil on a rock sample from the target formation with each of the second set of brine recipes.

13. The method of claim 4, wherein using the model to rationalize the results comprises:
determining surface complexation reactions for the target formation with divalent cations and the one or more salt additives to form a surface complexation model comprising the surface complexation reactions; and
varying intrinsic equilibrium constants of the surface complexation reactions to match the measured zeta-potentials.

14. The method of claim 13, wherein the target formation comprises a carbonate formation.

15. The method of claim 14, wherein the one or more salt additives comprises a phosphate salt and the surface complexation reactions comprise:

| | Equilibrium |
|---|---|
| | Constant |
| Calcite Surface Reaction | (log₁₀ Kᵢₙₜ) |
| >CaOH + Mg²⁺ + H₂PO₄⁻ ↔ >CaOMgHPO₄⁻ + 2H⁺ | −7.35 |
| >CaOH + Ca²⁺ + H₂PO₄⁻ ↔ >CaOCHPO₄⁻ + 2H⁺ | −6.65 |
| >CaOH + Mg²⁺ + H₂PO₄⁻ ↔ >CaOMgH₂PO₄ + H⁺ | −2.65 |
| >CaOH + Ca²⁺ + H₂PO₄⁻ ↔ >CaOCH₂PO₄ + H⁺ | −4.35 |
